(19) United States
(12) Patent Application Publication
(10) Pub. No.: US 2024/0235307 A9
(43) Pub. Date: Jul. 11, 2024

(54) ELECTRICAL CONDUCTOR FOR A STATOR OF A ROTARY ELECTRIC MACHINE, AND METHOD FOR MANUFACTURING SAME

(71) Applicants: NIDEC PSA EMOTORS, CARRIERES SOUS POISSY (FR); SKYAZUR, TOURCOING (FR)

(72) Inventors: Cyril MOYA, ANDEVILLE (FR); Nicolas LANGLARD, LOOS (FR); Sébastien DESURMONT, MARQ-EN-BAROEUL (FR); Patrick ALLAIN, LA CELLE ST. CLOUD (FR)

(21) Appl. No.: 18/548,180

(22) PCT Filed: Mar. 15, 2022
(86) PCT No.: PCT/FR2022/050463

§ 371 Date: Aug. 28, 2023

(30) Foreign Application Priority Data
Mar. 29, 2021 (FR) 2103172

(51) Int. Cl. H02K 3/28; H02K 15/04

(52) U.S. Cl. CPC H02K 3/28; H02K 15/0421; H02K 2213/03

(57) ABSTRACT

The invention relates to an electrical conductor for a stator of a rotary electric machine, in the form of a U-shaped hairpin, having: —first and second legs intended to extend axially in a first slot A and a second slot R, respectively, of the stator, —a bundle portion connected to the first and second legs of the electrical conductor in each case by an oblique portion, —the two oblique portions being in the form of a helical portion.

### CROSS-REFERENCE TO RELATED APPLICATIONS

This application is the US National Stage under 35 USC § 371 of International Application No. PCT/FR2022/050463, filed Mar. 15, 2022, which claims the priority of French application 2103172 filed on Mar. 29, 2021, the content (text, drawings and claims) of both said applications being incorporated by reference herein.

### BACKGROUND

The devices and methods described herein relate to rotary electric machines and, more particularly, to the stators for such machines.

More particularly, electrical conductors intended to be inserted into slots of a stator of a rotary electric machine are described. The associated winding, the stator and the corresponding rotating electrical machine and the method for manufacturing such electrical conductors are also described.

More particularly, the devices and methods described herein relate to synchronous or asynchronous AC machines. In particular, they relate to traction or drive machines for electric motor vehicles (Battery Electric Vehicles) and/or hybrid motor vehicles (Hybrid Electric Vehicles—Plug-in Hybrid Electric Vehicles), such as private cars, vans, trucks or buses. The present description also applies to rotary electric machines for industrial and/or power generation applications, in particular naval, aerospace or wind turbine applications.

International application WO 2015/180811 discloses an undulating three-phase winding, wound continuously.

Application US 2014/0339948 relates to a method for shaping pins, which are held over their entire length and wherein the wire is die pressed, that is, shaped to the shape of the tool.

In application EP 3,622,614, the wires are clamped and pinched and they cannot slide relative to one another.

In the known stators, the parts of the electrical conductors emerging from the stator mass can slide relative to one another, and will twist in an uncontrolled manner, which can leave enough space for the passage of the phase outputs and any phase returns.

There is a need to benefit from a rotary electric machine stator that is easy to assemble and allows effective filling of the slots, while ensuring satisfactory electromagnetic performance.

There is still a need to reduce the manufacturing cost of electric machines, in particular by simplifying the manufacture of the stator winding, for example by minimizing the number of parts to be used.

There is also a need to further improve the stators of electric machines and in particular to reduce torque ripple and AC Joule loss by induced currents, vibrations and electromagnetic noise.

There is also a need to have a method for manufacturing electrical conductors that allows the formation of electrical conductors with a satisfactory filling rate of the slots, allows rapid manufacturing of the electrical conductors, limits the quantity of electrical conductors used and can be effectively cooled.

### SUMMARY

The devices and methods described herein aim to meet all or part of these needs, and it achieves this aim, according to a first aspect, owing to an electrical conductor for a stator of a rotary electric machine, in the form of a U-shaped pin, having:
first and second legs intended to extend axially in a first slot A and a second slot R, respectively, of the stator,
a bundle portion connected to the first and second legs of the electrical conductor in each case by an oblique portion,
the two oblique portions being in the form of a helical portion.

The observation axis Y can be perpendicular to an axis of rotation of the machine, and parallel to a plane normal to the axis of rotation of the machine.

The oblique portion can be curved, in particular around an axis parallel to an axis of the stator, in order to conform to the circular shape of the stator wherein it is intended to be or is inserted. This curve can be observed when the electrical conductor is observed along an axis parallel to an axis of rotation of the machine. Prior to the curving of the electrical conductor, the portion in the form of a helical portion is rectilinear along all the observation axes.

The bundle portion has no so-called eye shape, which would increase its volume. The bulk of the bundle portion is thus reduced, both height wise and radially. The mass and the bulk of the stator are reduced as a result. It is possible to modulate the clearance between the various electrical conductors of the stator, and thus to improve the thermal conductivity and to improve their cooling. It is also possible to improve the interleaving of the electrical conductors in the stator, and in particular at the phase outputs and the bridges. Furthermore, the volume of material, in particular of copper, necessary for the electrical conductors may be reduced, and the cost and cooling of the stator can thus be improved. Finally, the linear resistance of the phases, that is, the total length of a phase, of the stator can be reduced, thus leading to lower heating, which also allows reduced Joule losses.

The electrical conductor allows the height of the bundle ends to be reduced on the side opposite the welds, which is advantageous for minimizing the bulk of the machine and the quantity of material, in particular copper, necessary for the electrical conductors. There is thus better compactness of the stator, including when it is assembled, and therefore of the resulting machine, which may in particular be shorter. The shaft of the rotor can be shorter, the casing can be shorter, the integration of the machine into its usage environment can be facilitated and the material to be melted or machined can be reduced. A shorter machine improves the overall rigidity and reduces vibrations. Forces on the bearings are also decreased, which allows improvements in their lifetime. Finally, the overall mass of the machine can be minimized. Moreover, the length of the stator can be increased with the same total length of the machine.

In one embodiment, the spacing between the pins at the slot outlet can be constant or substantially constant. This can facilitate the cooling of the electrical conductors.

An object is in particular an electrical conductor for a stator of a rotary electric machine, in the form of a U-shaped pin, comprising several strands, the electrical conductor comprising:
first and second legs intended to extend axially in first slot A and a second slot R, respectively, of the stator, the strands of the first leg being arranged in the first slot in a radially inverse order to the strands of the second leg in the second slot,
a bundle portion connected to the first and second legs of the electrical conductor in each case by an oblique portion,
the two oblique portions being in the form of a helical portion.

The electrical conductor may comprise a single strand or else at least two strands.

The electrical conductor may comprise several strands, in particular three strands. As each electrical conductor comprises several strands, a reduction in losses by induced currents, or Joule AC losses, is achieved, which is particularly advantageous when the operating speed is high. The heat transfer to the cold source is also facilitated.

In the electrical conductor, the different strands are free relative to one another outside the stator. They can in particular slide relative to one another during manufacturing. This allows any twisting of the strands to be avoided while allowing their relative sliding during manufacturing. There is no twisting of the strands in the oblique portions or in the bundle portion. The bundle portion thus retains a controlled volume. There is good contact between the various strands, including at the bundle portion.

The strands of the first leg of an electrical conductor can be arranged in the first slot in a radially inverse order to the strands of the second leg of the same electrical conductor in the second slot. The reversal of the order of the strands of the first leg in the first slot, relative to the order of the strands of the second leg of the same electrical conductor in the second slot, also called “transposition,” makes it possible to minimize the circulation currents between the strands of the same electrical conductor in each of the first slot and the second slot.

Preferably, the first and second legs are rectilinear.

In a variant, they may be helical when the stator is twisted.

The length G of an oblique portion can be given by the following relationship: G=[(x*D/2)−(Rn−Rn*sin α)−(C/2)]/cos α,
where x is the number of teeth between the two legs of the electrical conductor,
D is the median pitch corresponding to the gap between two consecutive slots of the stator,
Rn is the radius of curvature of a strand of the electrical conductor between the oblique portion and a vertical portion,
α is the angle such that sin α=(la+e)/D,
C is the length of the bundle portion measured between the two oblique portions, la is the width of a strand of the electrical conductor,
e is the spacing at the slot outlet between two electrical conductors, measured in a plane perpendicular to a general plane of the U-pin. The distance e also corresponds to the spacing between two helical portions.

The length C of the bundle portion measured between the two oblique portions may be less than 3D, better still less than 2D, where D is the median pitch corresponding to the gap between two consecutive slots of the stator. In one embodiment, the length C of the bundle portion measured between the two oblique portions may be greater than 0.5 D, better still greater than D.

The length C of the bundle portion measured between the two oblique portions may substantially correspond to the sum of the width of a strand added to the median pitch D, which corresponds to the gap between two consecutive slots of the stator. The length C of the bundle portion can be large enough to prevent the enamel of the bundle and the strands from being too stressed. The length C of the bundle portion may be less than 2 times the median pitch, or even less than 1.5 times the median pitch, better still less than 1.3 times the median pitch A.

The height H of the bundle portion relative to the first and second legs may be less than 70 mm, better still less than 65 mm, or even less than 50 mm, or even less than 40 mm, better still less than 35 mm, more preferably less than 30 mm. The height of the bundle portion between the top of the legs intended to extend axially in the slots of the stator, that is, between the top of the stator mass, or the top of the stack of laminations of the stator, and the top of the bundle portion, is measured.

The thickness B of the electrical conductor at the bundle portion can be substantially equal, being very slightly greater than the thickness of the strands of the electrical conductor, with a slight supplement e due to the deformation of the electrical conductor. The supplement e may be of the order of a few percent of the thickness of a strand, in particular less than 50% of the thickness of a strand, better still less than 40%, or even less than 30%, even better still less than 20% of the thickness of a strand. In one embodiment, the supplement e may be zero. In another alternative embodiment, in the case where there is an elongation of the strands and/or a compression thereof, it is possible to have a negative supplement.

Stator and Machine

The object is also, according to another of its aspects, independently or in combination with the foregoing, a stator comprising a stator mass comprising slots, electrical conductors accommodated in the slots, at least part of the electrical conductors, or even a majority of the electrical conductors, better all the electrical conductors, being as defined above.

The stator mass comprises teeth defining the slots between them, the teeth being attached to a yoke of the stator.

The first and second slots may be non-consecutive. Reference may be made to the forward slot and the return slot, respectively.

The first and second slots can be separated by a number of slots between 3 and 20, better still between 6 and 16, for example 7 or 8, or 10 or 11 slots.

The stator may comprise two electrical conductors per slot. In one embodiment, the stator may comprise two columns of strands of electrical conductors.

In an “electrical conductor,” the current of the same phase of a winding path circulates. Several conductors in series form a “coil.” The number of coils per phase is at most equal to the number of poles of the stator or to the number of pairs of poles.

In each slot, there may be one or several layers. The term “layer” refers to the series of conductors belonging to the same phase arranged in the same slot. In each layer of a slot, there are the electrical conductors of a same phase. In general, the electrical conductors of a stator can be distributed into one layer or into two layers. When the electrical conductors are divided into a single layer, each slot only accommodates electrical conductors of the same phase.

The electrical conductors can be distributed in only two layers. In this case, one or more slots can accommodate electrical conductors of two different phases. This is always the case for a winding with shortened pitch. In one embodiment, the winding may not comprise more than two layers. In one embodiment, it is notably devoid of three or four layers.

The electrical conductors can form a distributed winding. The winding can be waved or interleaved. The electrical conductors can form a fractional winding.

An outer diameter of the set of electrical conductors of the stator, defined by the bundle portions, can be smaller than the outer diameter of the slots plus 0 to 6 times the thickness of a strand, in particular four times the thickness of a strand.

Furthermore, an inner diameter of the set of electrical conductors of the stator, defined by the bundle portions, may be greater than an inner diameter of the slots, measured on the side of the air gap.

The devices and methods described herein also relate, according to another aspect, independently or in combination with the foregoing, to a rotary electric machine comprising a stator as defined above and a rotor.

The first leg can be arranged closer to the rotor than the second leg. The second leg can be arranged closer to the yoke of the stator than the first leg. Alternatively, the first leg can be arranged closer to the yoke of the stator than the second leg, and the second leg can be arranged closer to the rotor than the first leg.

Method for Manufacturing an Electrical Conductor

Also related herein, according to another aspect, independently or in combination with the foregoing, is a method for manufacturing an electrical conductor for a stator of a rotary electric machine as defined above.

According to another aspect, also related herein is, independently or in combination with the foregoing, a method for manufacturing an electrical conductor for a stator of a rotary electric machine, comprising the following steps:
(a) providing a bundle of one or more strands folded into a U, the strands in particular being bent flat, the bundle folded into a U comprising a bundle portion and two legs,
(b) separating the two legs in order to form two rectilinear oblique portions, the separation being carried out in two opposite directions parallel to the flat of the strands,
(c) folding back the oblique portions toward the inside, so as to form first and second legs of the electrical conductor each connected to the bundle portion by a rectilinear oblique portion, the first and second legs extending parallel to one another.

The term “bent flat” is understood to mean that the strand is folded over its larger width, when seen in cross section. Preferably, the strand is not bent edgewise.

In one embodiment, the strand(s) may, as a variant, be bent edgewise. This may in particular be advantageous when a slot accommodates several columns of electrical conductors.

In cross section, the strand is of generally rectangular shape, comprising two large sides each forming the “flat of the strand” and two small sides each forming the “edge of the strand.”

The bundle preferably comprises several strands, for example three strands.

The method allows proper control of the deformation of the electrical conductors during the formation of the pin, and therefore proper control of the spacing between the various electrical conductors of the stator, which is advantageous in terms of thermal conductivity and cooling. The consumption of material, in particular of copper, can be reduced, and the mass and bulk of the resulting stator can also be reduced. Finally, better interleaving of the phase outputs and of the bridges in the stator is obtained.

During the separation step (b), the bundle folded into a U can be channeled at the apex of the U by applying pressure under the bundle in the bottom of the U. Pressure can also be applied, simultaneously, above the bundle, at the apex of the bundle folded into a U.

During this channeling of the bundle, the bundle is left free to deform; it is not kept gripped at this level. The pressure(s) exerted are applied vertically, parallel to an axis of rotation of the machine. For the pressure applied under the bundle in the bottom of the U, it is possible to use a localized bearing, for example a tip, or a bar, or a sphere, for example in one embodiment, a rather fine tip, for example polished or rounded, so as not to damage the enamel. For the pressure applied above the bundle, at the apex of the bundle folded into a U, a tip or a flat tool can be used.

Thus, a bearing point is created to channel the bundle and the strands, but these are not completely clamped. No pressure is applied perpendicularly to the bundle folded into a U at the bottom of the U. The bundle and the strands can extend and slide on one another. There is no eye of the electrical conductor.

In step (a), the bundle can be folded around a shape part, in particular a bending dowel. The radius of the bending dowel may be between 0.5 and 2 times the thickness of a strand. In one embodiment, the radius of the bending dowel may be substantially equal to the thickness of a strand. The thickness of the strand may for example be 1.41 mm. The diameter of the bending dowel may for example be 3 mm. The shape part can be used only for the folding step (a), but can be removed for the separation step (b).

In the method, it is possible not to hold the bundle portion during separation step (b). On the contrary, the two legs of the bundle folded into a U shape are held during the separation step (b). During this separation step (b), the bundle portion is left free to deform.

In the case where the bundle comprises several strands, the strands can slide relative to one another.

During step (b) of separation, the two legs of the bundle are held in guides, and they are moved apart in two opposite directions parallel to the flat of the strands. The two legs are held at the future oblique parts. Such a deformation step (b) is advantageously identical, regardless of the final pitch of the electrical conductor being manufactured. This holding makes it possible to prevent the oblique parts from twisting, while allowing the strands to slide relative to one another in the guides.

In step (c), the rectilinear oblique portions can be held on the one hand and the first and second legs can be held on the other hand in order to fold them inwards relative to the rectilinear oblique portions. The gap obtained between the two legs corresponds to the pitch of the stator for which the electrical conductor is intended, independently of the curvature.

The oblique portions can be held in the separation step (b) and the folding step (c) with the same tools. During the folding step (c), like in the separation step (b), the bundle folded into a U can still be channeled at the apex of the U by applying pressure under the bundle in the bottom of the U. Pressure can also be applied, simultaneously, above the bundle, at the apex of the bundle folded into a U. As a variant, this pressure cannot be exerted.

During the various steps that have just been described, the two oblique portions remain rectilinear and untwisted. In order to conform to the circular contour of the stator, it may be necessary to shape them.

To this end, the method may comprise the following additional step:
(d) curving the oblique portions, according to the contour of the stator, the oblique portions becoming a helical portion.

The curving step (d) takes place after the other steps. During this curving step (d), the two legs of the electrical conductor are held. It is possible either to hold a single leg of the pin and to rotate the second leg relative to the first leg, or to rotate both legs relative to one another.

During this curving step (d), the bundle portion is not held. The bundle and the free strands are left free to lengthen and slide on one another.

The oblique portions resulting from the curvature are in the form of a helical portion, but are not twisted.

In the bundle portion, the bundle and the strands can be twisted over a length C that may substantially correspond to the sum of the width of a strand added to the median pitch, which corresponds to the gap between two consecutive slots of the stator.

The first and second legs are then intended to extend axially in a first slot A and a second slot R, respectively, of the stator.

The angle of curvature and the pitch can be chosen based on the number of poles, the number of teeth, and/or the number of stator phases. In one embodiment, the angle of curvature may be 60° or 52.5°, based on the pins. The stator may for example comprise pins framing 8 teeth having an angle of 60° and pins framing 7 teeth having an angle of 52.5°. In another embodiment, the angle of curvature may be 62.7° or 57°, depending on the pins. The stator may for example comprise pins framing 11 teeth having an angle of 62.7° and pins framing 10 teeth having an angle of 57°.

At least one first electrical conductor accommodated in a first slot can be electrically connected to a second electrical conductor accommodated in a second slot, at the outlet of said slots.

All the electrical conductors having a free end located at the same circumferential position around the axis of rotation of the machine, regardless of their radial position, can be electrically interconnected.

The stator may comprise a phase connector comprising metal elements connected to electrical conductors of the stator. The metal elements may be arranged radially outwardly or inwardly relative to the electrical conductors to which they are connected. The metal elements connected to conductors of the stator windings can be held by an insulating support. Furthermore, the phase connector may have connection tabs to a power bus. The machine can thus be connected to an inverter, electrically connected to the connection tabs of the connector.

Pins

At least some, or even a majority, of the electrical conductors may be in the form of U or I pins. The pin can be U-shaped (“U-pin”) or straight, being I-shaped (“I-pin”).

The pin and flat electrical conductors increase the filling coefficient of the slot, making the machine more compact. Owing to a high filling coefficient, the thermal exchanges between the electrical conductors and the stator mass are improved, which makes it possible to reduce the temperature of the electrical conductors inside the slots.

Furthermore, the manufacture of the stator can be facilitated owing to the electrical conductors being in pin form. Finally, since the pins do not need to have open slots, it is possible to have closed slots which make it possible to hold the pins, and it is thus possible to eliminate the step of inserting stator shims.

Some of the electrical conductors, or even a majority of the electrical conductors, extend axially in the slots. The electrical conductors can be introduced into the corresponding slots by one or both axial ends of the machine.

An I-shaped electrical conductor has two axial ends each placed at one of the axial ends of the stator. It passes through a single slot, and can be welded at each of its axial ends to two other electrical conductors, at the axial ends of the stator. The stator may for example comprise 6, 10, 12, 14, 18, 22 or 26 I-shaped electrical conductors, the other electrical conductors possibly all being U-shaped.

The stator may not have an I-shaped electrical conductor.

A U-shaped electrical conductor has two axial ends both placed at one of the axial ends of the stator. These two axial ends are defined by the two legs of the U. It passes through two different slots, and can be welded at each of its axial ends to two other electrical conductors, at the same axial side of the stator. The bottom of the U, that is, the side of the U forming the bundle or coil head, is arranged on the other axial side of the stator.

At least a part of the electrical conductors, or even a majority of the electrical conductors, may be in the form of U-pins.

Furthermore, the bulk of the electrical conductors at the coil heads is reduced. This facilitates the interleaving of the electrical conductors.

Strands

Each electrical conductor may comprise several strands (also called “wire”). “Strand” means the most elementary unit for electrical conduction. A strand may have a round cross-section, in which case it may be called a “wire”, or flat. The flat strands can be shaped into pins, for example U-pins or I-pins. Each strand is coated with an insulating enamel.

The fact that each slot can comprise several conductors and/or several strands makes it possible to minimize losses by induced currents, or AC Joule losses, which vary with the square of the supply frequency, which is particularly advantageous at high frequency and when the operating speed is high. The heat transfer to the cold source is also facilitated. It is thus possible to obtain better efficiency at high speed.

When the slots are closed, a reduction in the leakage fluxes seen by the conductors can be obtained, which leads to a reduction in the eddy current losses in the strands.

In one embodiment, each electrical conductor may comprise several pins, each forming a strand, as explained above. All the strands of the same electrical conductor can be electrically connected to each other at the outlet of the slot. The strands electrically connected to each other are placed in short circuit. The number of strands electrically connected together may be greater than or equal to 2, being for example between 2 and 12, being for example 3, 4, 6 or 8 strands.

Several strands can form the same electrical conductor. The same electric current of the same phase circulates in all the strands of the same electrical conductor. All the strands of the same electrical conductor can be electrically connected to each other, in particular at the outlet of the slot. All the strands of the same electrical conductor can be electrically connected to each other at each of their two axial ends, in particular at the outlet of the slot. They can be electrically connected in parallel.

All the strands of all the electrical conductors having a free end located at the same circumferential position about the axis of rotation of the machine, regardless of their radial position, can be electrically connected to one another.

In one embodiment, each electrical conductor comprises three strands. In the case where a slot comprises two electrical conductors, a slot can therefore accommodate six strands, for example, distributed between the two electrical conductors.

In a variant, a slot comprises four electrical conductors. Each electrical conductor can comprise two strands. The slot then accommodates eight strands, distributed between the four electrical conductors.

The strands of the same electrical conductor can be in contact in pairs over their entire length. They can in particular be in contact at the coil heads. Furthermore, they may in particular be in contact at the weld ends. They can be contiguous. In one embodiment, the strands can be welded in pairs of three strands. Such a configuration allows good optimization of the space available in and around the stator. Improvements in compactness are in particular achieved in terms of the height of the bundles. Furthermore, the risks of short circuits between electrical conductors can be reduced.

The strands can be positioned in the slot so that their circumferential dimension about the axis of rotation of the machine is greater than their radial dimension. Such a configuration allows a reduction in eddy current losses in the strands.

A strand may have a width of between 1 and 5 mm, for example of the order of 2.65 or 3 mm. The width of a strand is defined as its dimension in the circumferential direction about the axis of rotation of the machine.

A strand may have a height of between 1 and 5 mm, for example of the order of 1.25 or 1.8 mm. The height of a strand is defined as its thickness in the radial dimension.

The electrical conductors can be made of copper or aluminum or any other enameled conductive material, or coated with any other suitable insulating coating.

The stator mass can be produced by stacking laminations. The teeth can be connected together by material bridges, and on the opposite side by a yoke. The slots can be closed. They can be made entirely by cutting into the laminations. Each lamination of the stack of laminations can be made of a single piece.

Each lamination is for example cut from a sheet of magnetic steel or containing magnetic steel, for example steel 0.1 to 1.5 mm thick. The laminations may be coated with an electrically insulating varnish on their opposite faces before they are assembled within the stack. The electrical insulation can also be obtained by heat treatment of the laminations, where appropriate.

As a variant, the stator mass can be manufactured from a compacted or agglomerated magnetic powder.

The rotary electric machine can be synchronous or asynchronous. The machine may be a reluctance machine. It may be a synchronous motor or a synchronous generator.

The maximum rotational speed of the machine may be high, for example higher than 10,000 rpm, preferably higher than 12,000 rpm, for example from of the order of 14,000 rpm to 15,000 rpm, or even 20,000 rpm or 25,000 rpm. The maximum rotational speed of the machine may be lower than 100,000 rpm, or lower than 60,000 rpm, or even lower than 40,000 rpm, and preferably lower than 30,000 rpm.

The rotary electric machine may comprise a rotor. The rotor can be a permanent magnet rotor, with surface or buried magnets. The rotor may have a flow concentration. It can comprise one or more layers of magnets arranged in an I, a U or a V. In a variant, it may be a wound or squirrel cage rotor, or a variable reluctance rotor.

The diameter of the rotor may be less than 400 mm, better still less than 300 mm, and greater than 50 mm, better still greater than 70 mm, being for example between 100 and 200 mm.

The rotor may comprise a rotor mass extending along the axis of rotation and arranged around a shaft. The shaft may comprise torque transmission means for driving the rotor mass in rotation.

The rotor may or may not be cantilevered.

The machine may be placed into a casing on its own or inserted in a gearbox casing. In this case, it is placed in a casing that also houses a gearbox.

Method for Manufacturing the Stator

Also related herein, independently or in combination with the foregoing, is a method for manufacturing a stator of a rotary electric machine, in particular a stator as defined above, wherein electrical conductors are arranged in the slots of a stator mass of the stator by inserting them into the corresponding slots via one or both axial ends of the stator.

At least one electrical conductor, or even a majority of the electrical conductors, introduced into the slots are in the form of a U-shaped pin. They can be shaped prior to their introduction into the slots. All the electrical conductors in the form of a U-shaped pin can be shaped, simultaneously or successively, then introduced into the stator mass simultaneously or successively.

The shaping may comprise a first step of assembling the strands of the same electrical conductor.

A final shaping step can be implemented after they are introduced into the slots. In particular, it may be the inclination of welding portions.

The same U-shaped electrical conductor can be arranged in two different non-consecutive slots of the stator mass of the stator. In the case where an electrical conductor is U-shaped, it can be soldered to two other electrical conductors on the same side of the machine.

Two I-shaped electrical conductors can be connected together inserted beforehand in two different non-consecutive slots of the stator mass of the stator. In the case where an electrical conductor is I-shaped, it can be soldered to another electrical conductor and to the connector, on two opposite sides of the machine.

It is possible to electrically connect all the electrical conductors together that have a free end located at the same circumferential position around the axis of rotation of the machine, regardless of their radial position.

### BRIEF DESCRIPTION OF THE DRAWINGS

The described methods and devices can be better understood on reading the following detailed description of one non-limiting embodiment thereof, and on examining the appended drawing, wherein:

FIG. 1 is a schematic and partial perspective view of a stator comprising electrical conductors.

FIG. 2 is a schematic and partial top view of the stator of FIG. 1.

FIG. 3 is a schematic and partial view of the stator of FIG. 1.

FIG. 4 is a schematic and partial side view of the stator of FIG. 1.

FIG. 5 is a schematic and partial side view of the winding of the stator of FIG. 1.

FIG. 6 is a schematic and partial side view of the winding of the stator of FIG. 1.

FIG. 7 is a schematic and partial cross sectional view of the stator of FIG. 1.

FIG. 8 is a schematic and partial side view of three electrical conductors of the stator of FIG. 1, taken in isolation.

FIG. 8a is a view similar to FIG. 8.

FIG. 9 is a schematic and partial longitudinal sectional view of the stator of FIG. 1.

FIG. 10a is a view of a bundle of strands intended to form an electrical conductor.

FIG. 10b is a side view thereof.

FIG. 11 shows step (a) of the method for manufacturing an electrical conductor.

FIG. 12a shows the separation step (b) of the method for manufacturing an electrical conductor.

FIG. 12b shows the separation step (b) of the method for manufacturing an electrical conductor, in side view.

FIG. 13 shows the end of the separation step (b) of the method for manufacturing an electrical conductor.

FIG. 14 is a view similar to FIG. 10b of the bundle at the end of the separation step (b).

FIG. 15 shows the folding step (c) of the method for manufacturing an electrical conductor.

FIG. 16a is a top view of the bundle at the end of the folding step (c).

FIG. 16b is a front view of the bundle at the end of the folding step (c).

FIG. 16c is a side view of the bundle at the end of the folding step (c).

FIG. 17a is a top view of the bundle during the curving step (d).

FIG. 17b is a front view of the bundle during the curving step (d).

FIG. 17c is a side view of the bundle during the curving step (d).

FIG. 18a is a top view of the bundle at the end of the curving (d).

FIG. 18b is a front view of the bundle at the end of the curving step (d).

FIG. 18c is a side view of the bundle at the end of the curving step (d).

FIG. 19 is a schematic and partial side view of electrical conductors each corresponding to a different alternative embodiment.

### DETAILED DESCRIPTION

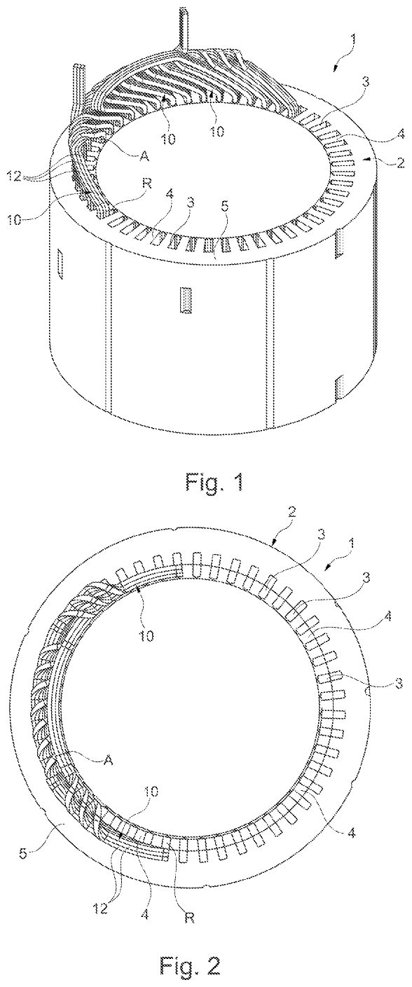

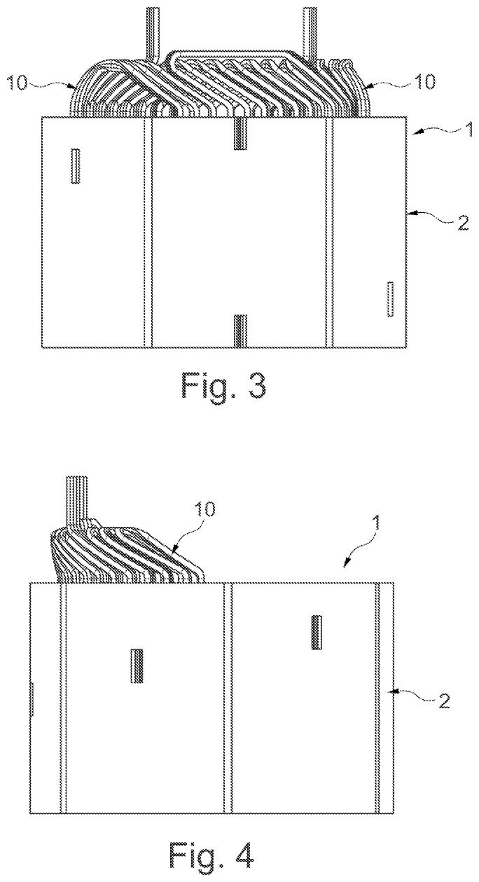

FIGS. 1 to 4 show a stator 1 of a rotary electric machine, comprising a stator mass 2 comprising slots 3 and teeth 4 defining therebetween the slots, the teeth being attached to a yoke 5.

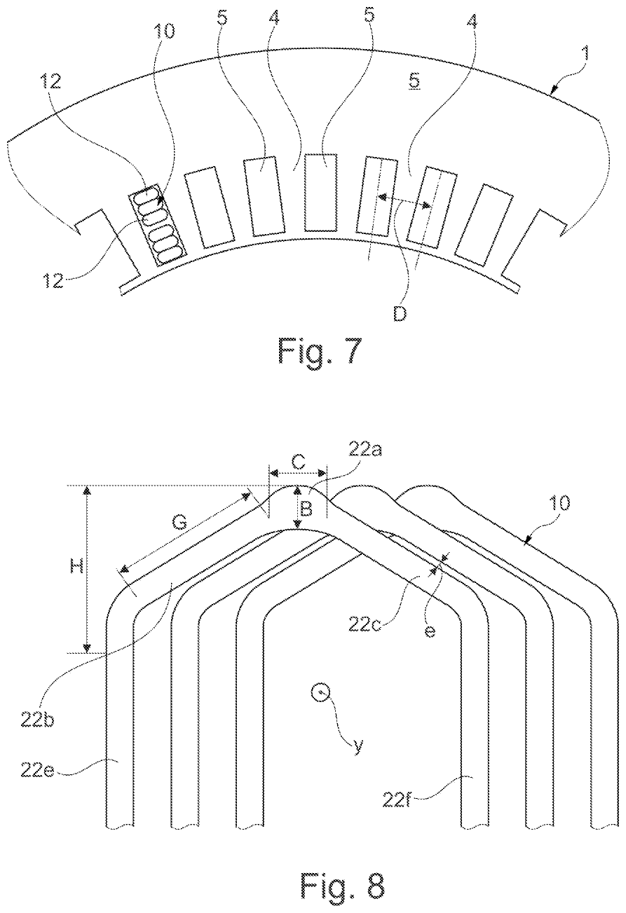

The stator 1 comprises a winding comprising electrical conductors 10 housed in the slots 3. In the example described, the stator comprises two electrical conductors per slot. Each electrical conductor comprises three strands 12, as can be seen in particular in FIG. 7.

The electrical conductors are of generally rectangular shape in cross section, with rounded corners. In the example described, they are radially superimposed in a single row. The circumferential dimension of an electrical conductor substantially corresponds to the width of a slot.

The electrical conductors 10 are made of copper or aluminum or any other enameled conductive material, or coated with any other suitable insulating coating.

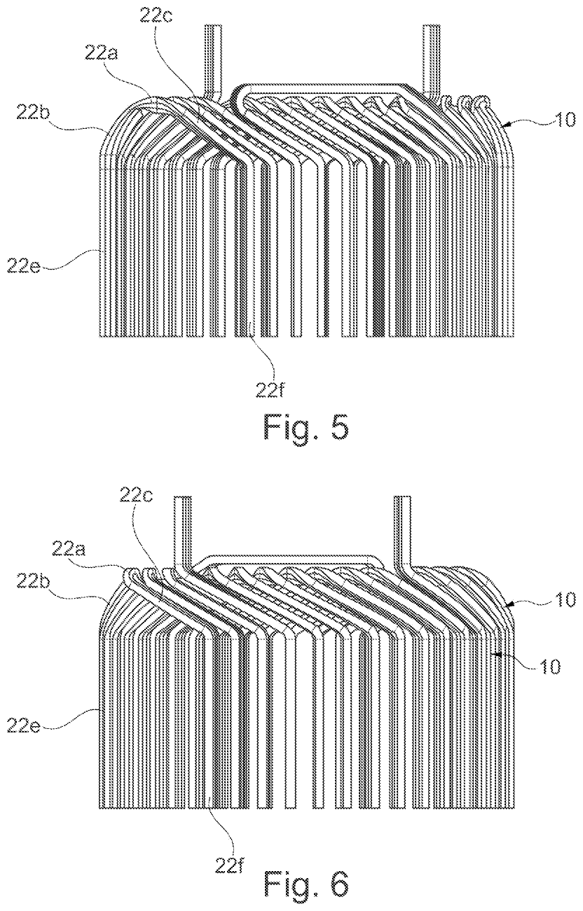

The electrical conductors are U-shaped, as can be seen in FIGS. 5 and 6. They each comprise first 22e and second 22f legs intended to extend axially in a first slot A and a second slot R, respectively, of the stator. The first and second legs are rectilinear. The first leg 22e can be arranged closer to the rotor than the second leg. The second leg 22f is arranged closer to the yoke of the stator than the first leg.

The strands of the first leg are arranged in the first slot A in a radially inverse order to the strands of the second leg of the same electrical conductor 10 in the second slot R.

Each electrical conductor further comprises a bundle portion 22a connected to the first and second legs 22e, 22f of the electrical conductor each by an oblique portion 22b, 22c.

Furthermore, the electrical conductors in pin form each have first 22e and second 22f legs that extend outside the slots by a welding portion, not visible in the figures.

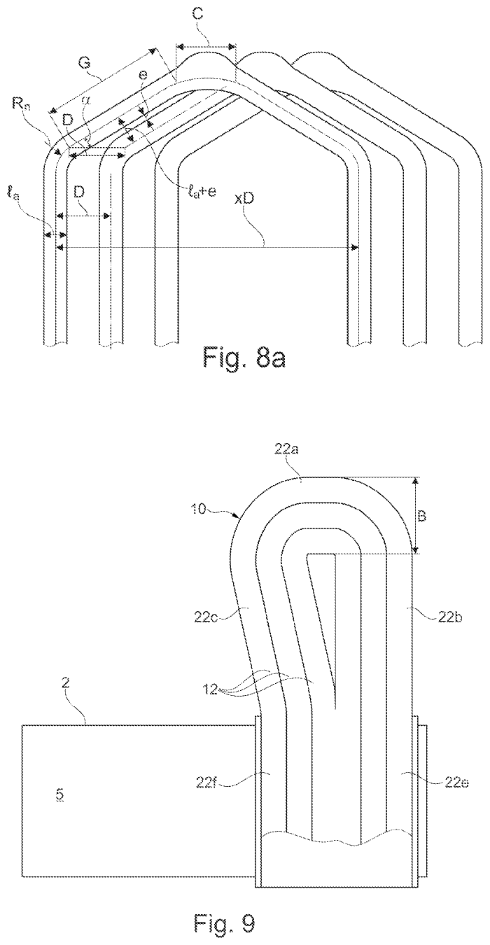

The two oblique portions 22b, 22c are in the form of a helical portion, as can be seen in FIG. 8. The observation axis Y of FIG. 8 is perpendicular to an axis of rotation of the machine, and parallel to a plane normal to the axis of rotation of the machine.

The two oblique portions 22b, 22c are also curved about an axis parallel to an axis of the stator, in order to conform to the circular shape of the stator wherein the electrical conductor is inserted, as can be clearly seen in FIG. 2. This curve can be observed when the electrical conductor is observed along an axis parallel to an axis of rotation of the machine.

The spacing e between the pins at the slot outlet is substantially constant.

In the example described, the length G of an oblique portion is of the order of 23 mm.

The length C of the bundle portion measured between the two oblique portions is of the order of 10 to 11 mm, for example 10.3 mm. The length C may substantially correspond to the sum of the width of a strand added to the median pitch D, which corresponds to the gap between two consecutive slots of the stator. In the example described, the median pitch D is of the order of 7.78 mm.

The height H of the bundle portion relative to the first and second legs, measured between the top of the legs intended to extend axially in the stator slots and the top of the bundle portion, is of the order of 22 mm.

The thickness B of the bundle at the bundle portion can be substantially equal, being very slightly greater than the thickness of the strands of the bundle, with a slight supplement e due to the deformation of the bundle. In the example described, the thickness B of the bundle is 4.23 mm.

As can be seen in FIG. 2, an outer diameter of the set of electrical conductors of the stator, defined by the bundle portions, is smaller than the outer diameter of the slots plus four times the thickness of a strand.

Furthermore, an inner diameter of the set of electrical conductors of the stator, defined by the bundle portions, is greater than an inner diameter of the slots, measured on the side of the air gap.

As shown in FIG. 8a, the length G of an oblique portion can be given by the following relationship:

G=[(x*D/2)−(Rn-Rn*sin α)−(C/2)]/cos α,
where x is the number of teeth between the two legs of the electrical conductor,
D is the median pitch corresponding to the gap between two consecutive slots of the stator,
Rn is the radius of curvature of a strand of the electrical conductor between the oblique portion and a vertical portion,
α is the angle such that sin α=(la+e)/D,
C is the length of the bundle portion measured between the two oblique portions, la is the width of a strand of the electrical conductor,
e is the spacing at the slot outlet between two electrical conductors, measured in a plane perpendicular to a general plane of the U-pin.

It can be seen in FIGS. 1 to 8 that the electrical conductors and the belts are perfectly integrated with each other.

Furthermore, the thickness of the bundle portions, measured radially, is substantially equal to the depth of the slot, as shown in FIG. 2. The bundle portions allow the passage of the rotor, on the one hand, and allow the bulk of the winding to be minimized, on the other hand.

The method for manufacturing an electrical conductor will now be described in detail.

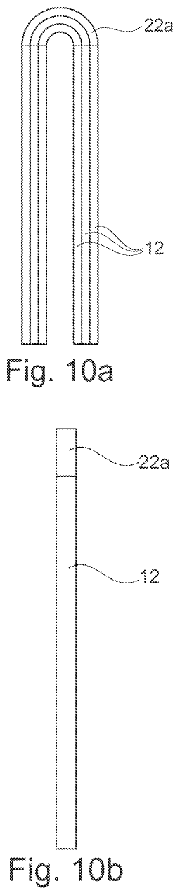

In a first step (a), a bundle of three strands is provided, the bundle being folded into a U shape, as shown in FIGS. 10a and 10b.

The strands are bent flat, the bundle folded into a U shape thus comprising a bundle portion 22a and two legs. The length of the strands has been adjusted, the strands have been straightened, and the end of the strands has stripped beforehand. When there are several strands, they may not have the same length, this difference compensating for the path of each strand in the U-shaped bundle.

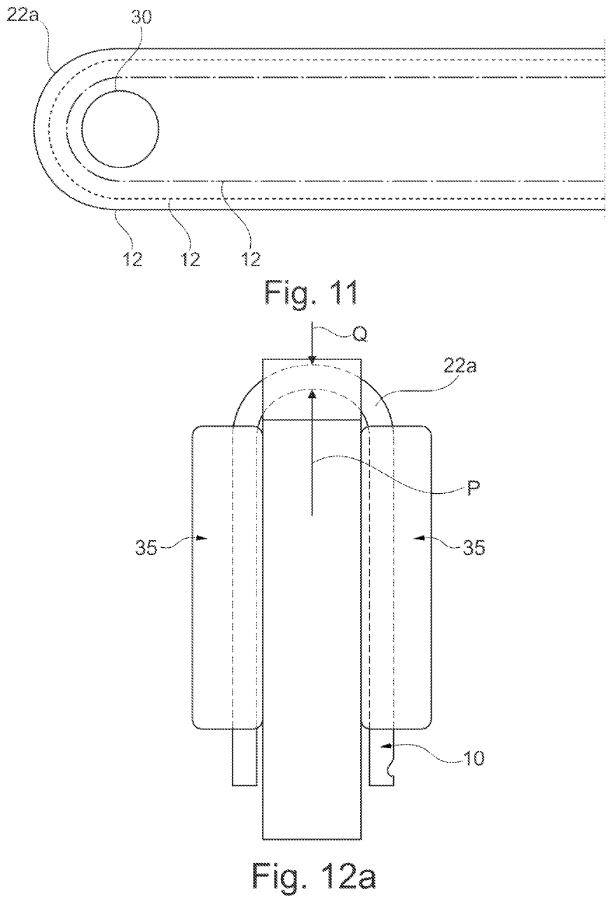

The bending is obtained in step (a) by folding the bundle about a shape part 30, as shown in FIG. 11. The radius of the shape part 30 is substantially equal to the thickness of a strand. The thickness of the strand may for example be 1.41 mm. The diameter of the bending dowel here is 3 mm.

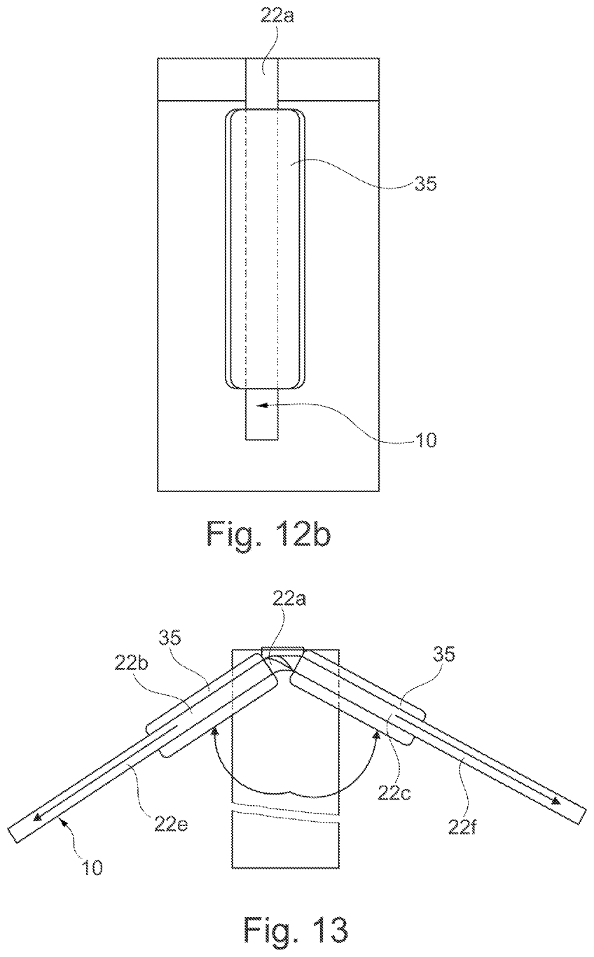

In a subsequent step (b), the two legs are separated in order to form two rectilinear oblique portions 22b, 22c, the separation being carried out in two opposite directions parallel to the flat of the strands, as shown in FIGS. 12a and 12b.

The two legs of the bundle folded into a U shape are held during the separation step (b), with guides 35. During this separation step (b), the bundle portion is left free to deform.

Furthermore, during this separation step (b), the bundle folded into a U shape is channeled at the apex of the U by applying pressure under the bundle in the bottom of the U. Pressure Q is also applied, in the described example, simultaneously, above the bundle, at the apex of the bundle folded into a U. The exerted pressures are applied vertically, parallel to an axis of rotation of the machine. During this channeling of the bundle, the bundle is left free to deform; it is not kept gripped at this level.

As shown in FIG. 13, while holding the two legs of the bundle in the guides 35, they are moved apart in two opposite directions parallel to the flat of the strands.

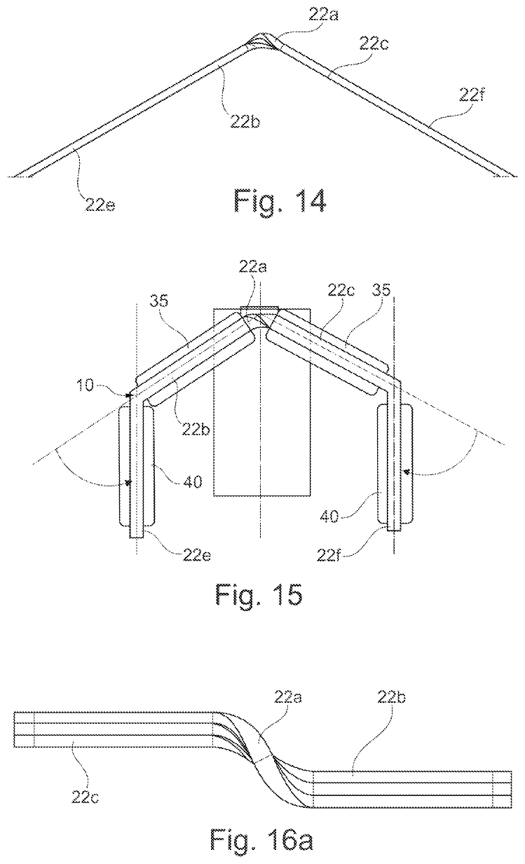

The electrical conductor as shown in FIG. 14 is then obtained.

In a subsequent step (c), the oblique portions are folded inwards, so as to form the first and second legs 22e, 22f of the electrical conductor each connected to the bundle portion 22a by the rectilinear oblique portions 22b, 22c. Thus, first and second legs 22e, 22f that extend parallel to one another are obtained. The gap obtained between the two legs corresponds to the stator pitch.

During this step (c), on the one hand the rectilinear oblique portions are held with the guides 35, and on the other hand the first and second legs are held with other guides 40 in order to fold them inwards relative to the rectilinear oblique portions, as shown in FIG. 15.

During the various steps that have just been described, the two oblique portions remain rectilinear. In order to conform to the circular contour of the stator, it is necessary to shape them.

To this end, the method comprises the additional step (d) of curving the oblique portions, according to the contour of the stator, the oblique portions becoming a helical portion.

The curving step (d) takes place after the other steps. During this curving step (d), the two legs of the electrical conductor are held in the guides 40, but the bundle portion is not held. The free strands are left free to lengthen and slide on one another.

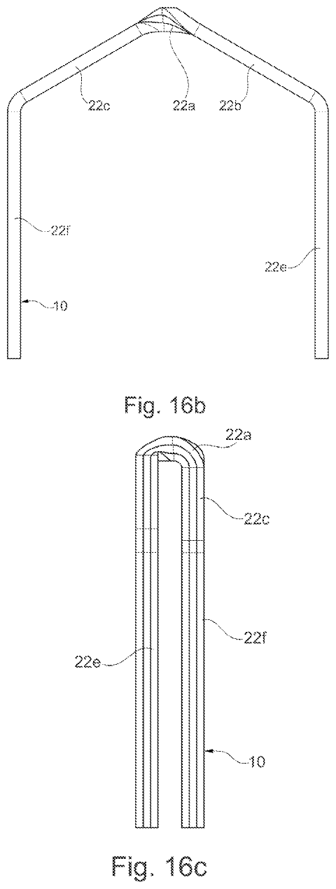

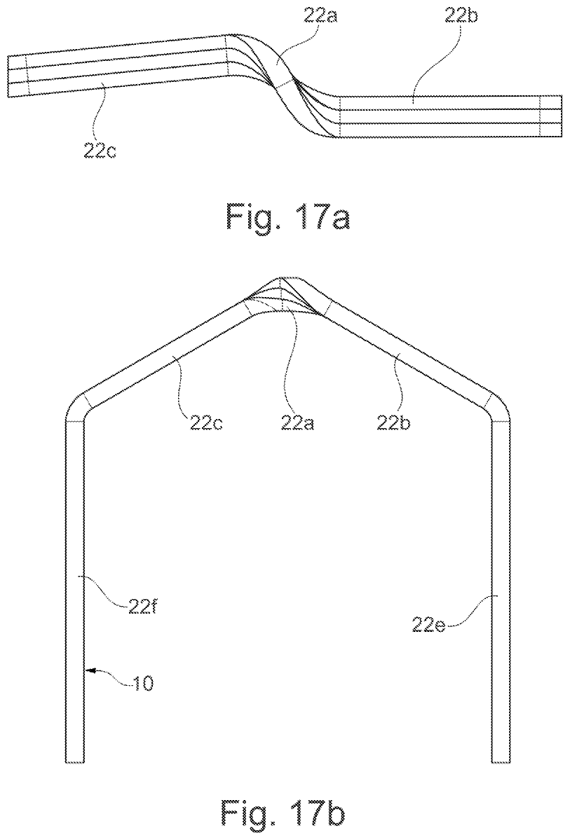

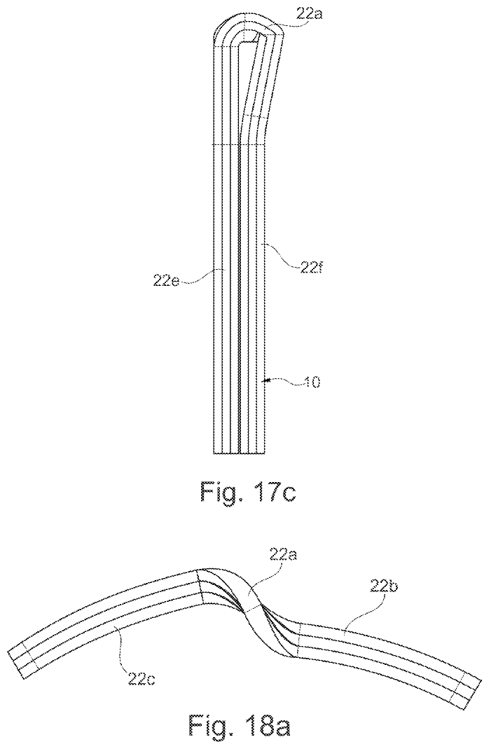

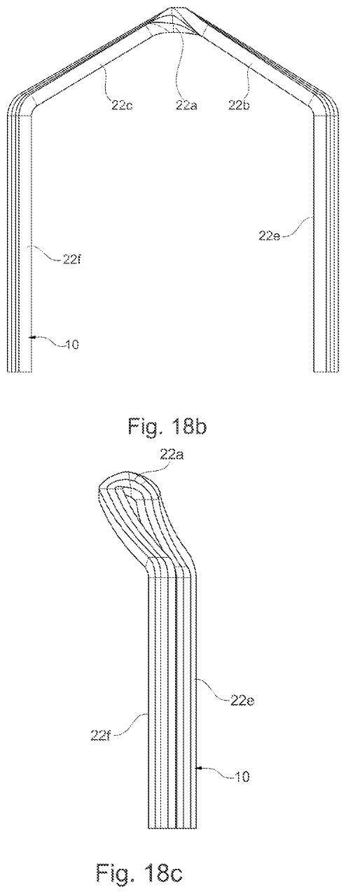

FIGS. 16a to 18c show the electrical conductor as the curvature proceeds. In FIGS. 16a to 16c, the curving has not begun. In FIGS. 17a to 17c, the curving is in progress. In FIGS. 18a to 18c, the curving is complete. It can be seen that the oblique portions resulting from the curving are helical, but are not twisted. In the bundle portion, the bundle and the strands are twisted.

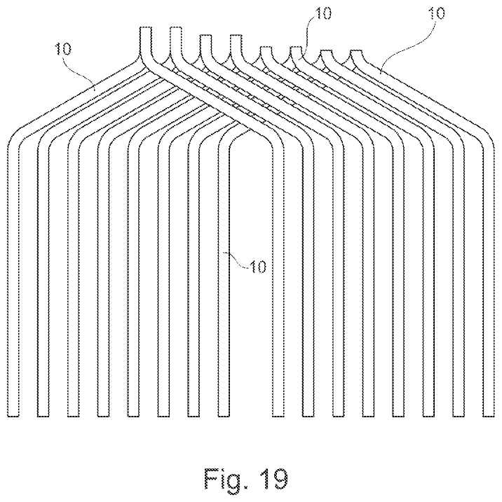

FIG. 19 shows a plurality of different electrical conductors, each corresponding to an alternative embodiment, for comparison purposes. There are four different embodiments, each with two electrical conductors placed side by side. These various embodiments differ by the height H of the bundle portion, and by the thickness B of the bundle at the bundle portion. It can be seen that B can vary based on the supplement e.

In the rightmost electrical conductors, the thickness B of the bundle at the bundle portion is substantially equal, being barely greater than the thickness of the strands of the bundle.

As a variant, in the leftmost electrical conductors, the bundle portion provides an eye that can be useful in order to promote the heat exchanges and the cooling of electrical conductors.

In the alternative embodiment shown, the stator comprises 48 slots, 48 teeth, 8 poles, electrical conductors in pin form each having first 22e and second 22f legs separated by 8 or 7 teeth.

In another alternative embodiment, the machine could comprise 60 slots, 60 teeth, 8 poles, electrical conductors in pin form each having first 22e and second 22f legs separated by 8 or 7 teeth.

In another alternative embodiment, the machine could comprise 63 slots, 63 teeth, 6 poles, electrical conductors in pin form each having first 22e and second 22f legs separated by 11 or 10 teeth.

In the preceding examples, the winding is wavy. It is not outside the scope of the present description when the winding is interleaved.

1. A stator of a rotary electric machine, comprising a stator mass comprising slots, electrical conductors accommodated in the slots, the stator comprising two electrical conductors per slot,
at least a part of the electrical conductors, or even a majority of the electrical conductors, more preferably all the electrical conductors, being U-shaped, comprising several strands, the electrical conductor comprising:
first and second legs intended to extend axially in first slot A and a second slot R, respectively, of the stator, the strands of the first leg being arranged in the first slot in a radially inverse order to the strands of the second leg in the second slot,
a bundle portion connected to the first and second legs of the electrical conductor in each case by an oblique portion (22b, 22c),
the two oblique portions (22b, 22c) being in the form of a helical portion.

2. The stator according to claim 1, comprising three strands.

3. The stator according to claim 1, wherein the thickness (B) of the electrical conductor at the bundle portion is substantially equal to the thickness of the strands of the electrical conductor, in particular very slightly greater.

4. The stator according to claim 1, wherein the length (C) of the bundle portion measured between the two oblique portions is less than 3D, where D is the median pitch corresponding to the gap between two consecutive slots of the stator.

5. The stator according to claim 1, wherein the height (H) of the bundle portion relative to the first and second legs is less than 70 mm.

6. The stator according to claim 1, wherein the length (C) of the bundle portion measured between the two oblique portions substantially corresponds to the sum of the width of a strand added to the median pitch (D), which corresponds to the gap between two consecutive slots of the stator.

7. The stator according to claim 1, wherein the first leg is arranged closer to the rotor than the second leg.

8. The stator according to claim 1, wherein an outer diameter of the set of electrical conductors of the stator, defined by the bundle portions, is smaller than the outer diameter of the slots plus 0 to 6 times the thickness of a strand.

9. A rotary electric machine comprising a stator according to claim 1 and a rotor.

10. A method for manufacturing an electrical conductor for a stator of a rotary electric machine, comprising the following steps:
(a) providing a bundle of one or more strands bent into a U, the strands in particular being bent flat, the bundle folded into a U comprising a bundle portion and two legs,
(b) separating the two legs in order to form two rectilinear oblique portions, the separation being carried out in two opposite directions parallel to the flat of the strands,
(c) folding back the oblique portions inwards, so as to form first and second legs of the electrical conductor each connected to the bundle portion by a rectilinear oblique portion, the first and second legs extending parallel to one another.

11. The method according to claim 10, wherein, during the separation step (b), the bundle folded into a U-shape is channeled at the apex of the U by applying pressure under the bundle in the bottom of the U.

12. The method according to claim 10, wherein the bundle portion is not held during the separation step (b).

13. The method according to claim 10, wherein in step (a), the bundle is folded about a shape part.

14. The method according to claim 10, wherein in step (c), the rectilinear oblique portions are held on the one hand, and the first and second legs are held on the other hand in order to fold them inwards relative to the rectilinear oblique portions.

15. The method according to claim 10, comprising the following additional step:
(d) curving the oblique portions, according to the contour of the stator, the oblique portions becoming a helical portion.

16. The stator according to claim 1, wherein the length (C) of the bundle portion measured between the two oblique portions is less than 2D, where D is the median pitch corresponding to the gap between two consecutive slots of the stator.

17. The stator according to claim 1, wherein the height (H) of the bundle portion relative to the first and second legs is less than 30 mm.

18. The stator according to claim 1, wherein an outer diameter of the set of electrical conductors of the stator, defined by the bundle portions, is smaller than the outer diameter of the slots plus four times the thickness of a strand.

19. The method according to claim 10, wherein in step (a), the bundle is folded about a bending dowel.
